(19) United States
(12) Patent Application Publication
(10) Pub. No.: US 2009/0223167 A1
(43) Pub. Date: Sep. 10, 2009

(54) Pierced drywall stud

(76) Inventor: Jeffrey A. Anderson, Belleville, MI (US)

Correspondence Address: STEPTOE & JOHNSON LLP, 1330 CONNECTICUT AVENUE, N.W., WASHINGTON, DC, 20036, US

(21) Appl. No.: 12/395,934

(22) Filed: Mar. 2, 2009

Related U.S. Application Data
(60) Provisional application No. 61/032,195, filed on Feb. 28, 2008.

(51) Int. Cl. E04C 3/04; B23P 17/00

(52) U.S. Cl. 52/849; 29/897.3

(57) ABSTRACT

A framing member incorporates a plurality of recesses along a portion of the member that are configured to receive a screw tip. The recesses are formed in the flange region or the connecting region. The recesses are formed by piercing or stamping the metal framing member. The configuration of the recesses can allow the manufacturer to further down gage the stud, resulting in a significant cost reduction opportunity and cost savings for the manufacturer, contractor as well as improved customer satisfaction.

### CLAIM OF PRIORITY

This application claims priority under 35 U.S.C. § 119(e) to U.S. Provisional Patent Application Ser. No. 61/032,195 filed Feb. 28, 2008, the entire contents of which is hereby incorporated by reference.

### TECHNICAL FIELD

The invention relates to building materials, and more particularly to a metal framing member for structural and non-structural building applications.

### BACKGROUND

The use of light gauge metal framing members for structural and non structural applications has grown in the residential and light commercial building industry due, in part, to volatile lumber costs and the inconsistent and unpredictable quality of wood studs. Although the use of metal in framing applications has increased over the last few years, a few issues have resulted in the rate of growth being inhibited. For example, over the last 5 years, the cost of steel has risen significantly. To offset rising cost of material, the producers have reduced the material thickness. The thickness reduction has exacerbated the negative effects of the thinner and more flexible metal. These negative effects have prohibited further material thickness reduction opportunities.

### SUMMARY

A method of manufacturing a framing member includes providing a formed metal sheet having a length and forming a plurality of recesses configured to receive and hold a screw tip in a region of the length of the metal framing member. The region where the recesses are formed can be a flange or a connecting region. The recess can have a diameter and depth sufficient to capture a portion of a thread of a screw. The recess can be formed by indenting, piercing the region or stamping the region. The recess can include a barrel. The plurality of recess can be configured in an array spaced specifically to allow the screw tip to easily find a void space without special consideration of the operator.

A method of manufacturing a framing member includes providing a formed metal sheet having a length, a web region and a flange, placing a plurality of slots along a portion of the length of the web region, forming a plurality of recess in the flange, and expanding the slots of the web region to form expanded slots having a web element and a web void, the metal sheet being heat treated. The formed metal sheet can be formed by roll forming. The recess can be formed by indenting, piercing or stamping the flange. The plurality of recesses can be configured in an array spaced specifically to allow the screw tip to easily find a void space without special consideration of the operator.

A metal framing member includes a formed metal sheet having a length and a plurality of recesses configured to receive and hold a screw tip in a region of the length. The region can be a flange or a connecting region. Each recess can include a barrel. The plurality of recesses can be configured in an array spaced specifically to allow the screw tip to easily find a void space without special consideration of the operator.

A metal framing member includes a formed metal sheet having a length, a web region and a flange, a plurality of slots along a portion of the length in the web region, and a plurality of recesses in the flange. The recess can include a barrel. The plurality of recesses can be configured in an array spaced specifically to allow the screw tip to easily find a void space without special consideration of the operator.

When the material thickness of a metal framing member is reduced, for example, to offset the rising cost of material, excessive flexing of the mounting flange can cause the drywall screw to deflect or skip off the stud flange and the drywall becomes damaged. This screw skipping results in lost productivity for the installer and damage to the wall being installed. To counteract this problem, manufacturers incorporated closely spaced dimples on the surface of the flange. These dimples help the screw stay on the face of the flange, to a larger deflection angle, resisting the tendency to skip off the flange during the screw installation process. The recent increase in flexibility of the flange has resulted in the installer being unable to apply enough pressure for the self tapping screw to penetrate the steel and thread appropriately into the flange. This can lead to a second undesirable effect that involves a significant drop in the ultimate stripping torque of the drywall screw. As the screw is seated into the drywall and the seating torque is applied, the thinner gage material strips out resulting in total loss of clamping force. This loss of clamping force results in expensive remedial work. The plurality of recesses contemplated by here can surprisingly allow material thickness to be reduced while having proper performance in comparison to the dimple approach.

Other embodiments are within the specification and the claims.

### DESCRIPTION OF DRAWINGS

FIG. 1 is a perspective view of a portion of the member with extruded recesses in two regions.

FIG. 2 is a profile view of a portion of the member with extruded recesses in one region.

FIG. 3 is a cross-sectional view of the member with extruded recesses in two regions.

FIG. 4 is a perspective view of a portion of the member having a web formed (but not expanded) in a first region and extruded recesses formed in a second region.

FIG. 5 is a perspective view of a portion of the member having a web formed and expanded in a first region and extruded recesses formed in a second region.

### DETAILED DESCRIPTION

This metal framing member described herein includes a region having recesses that are pierced through a thickness of the metal stud member.

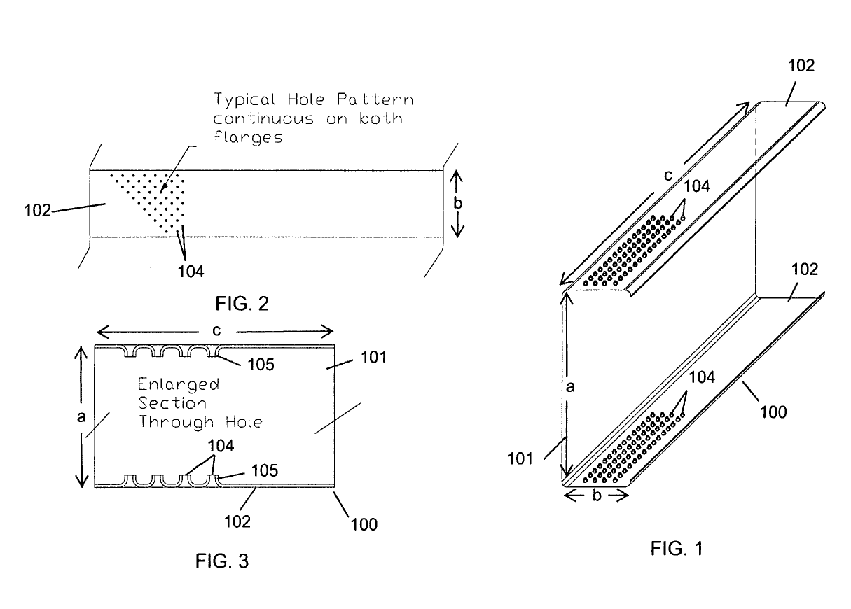

FIG. 1 is an isometric view of a portion of framing member 100. Framing member 100 includes a connecting region 101 connecting flanges 102 extending away from connecting region 101. The member can be manufactured in part or in whole through a roll forming process. Alternatively, a stamping process can be used to manufacture the member. Framing member 100 can include two connecting regions 101 connecting flanges 102 such that at least a portion of framing member 100 has a substantially tubular cross-section instead of a “U” or “C” shaped cross-section as depicted in FIG. 1. The member can be manufactured from steel or aluminum, or any other suitable metal in sheet form. The sheet can have a thickness of, for example, 35 to 10 gauge.

Referring to FIG. 1, the typical dimension a of connecting region 101 can be 1.5 inches to 11.5 inches but can be higher if required. The typical dimension b of flange 102 can be approximately 1.25 inches, although it can be adjusted for different applications. The final member length c can be 48 to 360 inches for wall studs and 2 feet to 40 feet for structural elements such as floor joists, although, generally, dimension c can be any length. Optimization of dimensions a, b and c will depend upon specific customer needs.

As shown in FIG. 1, flange 102 includes a plurality of recesses 104 passing through the thickness of flange 102. Recesses 104 are configured to receive and hold a screw tip, for example, a screw tip of a drywall screw that has penetrated a sheet of drywall installed against the face of flange 102. The recess can have a diameter and depth sufficient to capture a portion of a thread of a screw. Having this configuration allows a screw to begin auguring it's way into the member with little or no axial force (force directed into the member) but due to the rotational force and action of the drill motor into the screw. It has not been determined yet if a piercing all the way through is best, but we don't want to rule it out at this point. Recesses 104 are spaced specifically to allow a screw tip to easily find a recess 104 without special consideration of the operator. Recesses 104 are oriented and sized such that it would not affect the strength required to perform the normal functions of the stud. Typical hole sizes, if present, can be 0.000 inches to 0.100 inches in diameter. Typical spacing can be 0.050″ to 0.150″ apart.

FIG. 2 is a profile view of flange 102 including representative recesses 104. Recesses 104 can be provided on a portion of length c of flange 102, including the entire length c, according to the customer's needs. Recesses 104 can also be formed in connecting region 101 in addition to or instead of flange 102 according to the customer's needs.

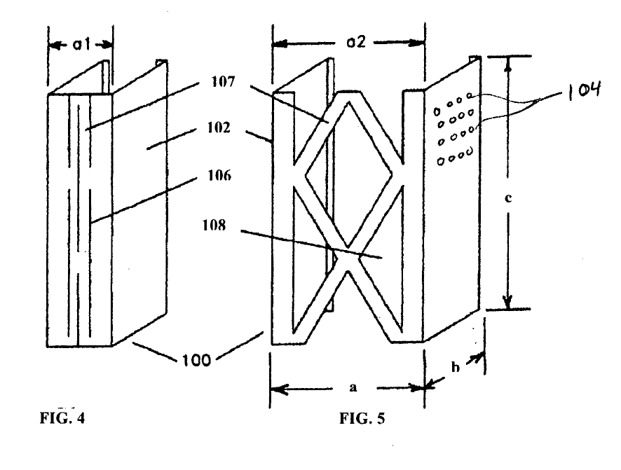

FIG. 3 is a cross-sectional view of framing member 100 taken along a plane parallel to connecting region 101 running through recesses 104. Recess 104 is shaped to force a drywall screw to immediately lock into flange 102 regardless of applied pressure and resulting angle of flange 102, thus preventing the drywall screw from deflecting or skipping off flange 102 and failing to engage framing member 100. A screw easily engages recess 104 in flange 102 and self threads into flange 102 with little or no applied pressure.

Recesses 104 can be piercings of the metal framing member 100. The piercings can be formed in flanges 102, as shown in FIG. 3. A pierced recess 104 includes a barrel 105 created during the piercing process. Barrel 105 can provide additional surface area for the screw tip to contact and can be significantly work hardened as a result of piercing, resulting in stronger steel. These characteristics increase the ultimate torque acting on the screw and can help prevent the screw from stripping or backing out of recess 104.

The framing member can be manufactured by a process, for example, that includes passing a sheet of metal from a coil through a series of form rolls that create the structural shape of the framing member. During the roll forming process, recesses 104 can be formed with a stamping die, a configured roll, laser or any other suitable method of creating the web slot. The configuration of recesses 104 can be adjusted to accommodate any desired location and number in order to create a framing member that enhances the thermal performance, cost reduction, tradesperson access, structural enhancement or any other desired objective not currently realized. The configuration of recesses 104 can allow the manufacturer to further down gage the stud, resulting in a significant cost reduction opportunity and cost savings for the manufacturer, contractor as well as improved customer satisfaction.

In another embodiment, a framing member can include a region having recesses for receiving and holding drywall screw tips and a web region formed during the manufacturing process. Slots can be formed in a pattern such that the region can be expanded during the manufacturing process. The expansion creates voids and web elements that extend at least one dimension of the framing member. The voids can create thermal resistance which reduces the thermal conductivity of the member and improves R-value of the ultimate structure. Because the metal is expanded, there is little or no scrap metal produced during manufacture.

FIG. 4 is an isometric view of a portion a framing member 100 prior to expansion into the final configuration but with the web slots 106 pierced into the web area. The placement, shape and length of the web slots 106 in the connecting region 101 having dimension a1 determine the width and length of the web elements 107 as well as the shape and size of the web voids. Flanges 102 extend away from the web region and include recesses 104. Framing member 100 can be manufactured in part or in whole through a roll forming process. Alternatively, a stamping process can be used to manufacture the member. The member can be manufactured from steel or aluminum, or any other suitable metal in sheet form. The sheet can have a thickness of, for example, 24 to 10 gauge.

Referring to FIG. 5, which depicts an expanded framing member, the typical dimension b of flange 102 can be approximately 1.5 inches, although it can be adjusted for different applications. Web area dimension a1 in the region increases during the manufacturing process by expanding the slots to become significantly wider until the web area reaches a final dimension a2 is shown on FIG. 5. The final quantity, shape and width and length of the web slots determine the size of web voids 108 and web elements 107 are selected to optimize all of the objectives and limitations of the material to be formed into the final shape. Optimization will depend upon specific customer needs. Dimension a2 can be 1.5 to 2.5 inches or 2.5 inches to 11.5 inches but can be higher if required. The final member length c can be 48 to 360 inches for wall studs and 2 feet to 20 feet or up to 40 feet for structural elements such as floor joists, although, generally, dimension c can be any length.

The framing member can be manufactured by a process, for example, that includes passing a sheet of metal from a coil through a series of form rolls that create the structural shape of the framing member. During the roll forming process, the web slots are pierced into the region to be expanded, such as connecting region 101. The piercing can be performed with a stamping die, a configured roll, laser or any other suitable method of creating the web slot. The web slot configuration can be adjusted to accommodate any desired shape or length in order to create a web void or web element that enhances the thermal performance, cost reduction, tradesperson access, structural enhancement or any other desired objective not currently realized.

After the web slots have been incorporated into the region of the member, the member can be expanded by moving the flanges perpendicularly opposed to one another until the desired width a2 is obtained. The expansion process can be performed in several ways including passing the member over a tapered forming block during the roll forming process. For example, the unexpanded member can be forced over a tapered forming block that fits between the two flanges. As the flanges move down forming line and over the tapered forming block, the flanges move progressively apart until reaching the desired width a2 shown in FIG. 5. An alternative to a tapered forming block can be rolls or a block including rolls attached to the forming block. An alternative method of expansion by rolling can include expanding using a mechanical or hydraulic mechanism that locks onto the flanges on the member and move them apart to the desired width a2. The expansion can extend a dimension by a factor of 10% to 300%, 20% to 250%, or 50% to 100%.

The final width determines the overall width of the member as well as the final configuration and dimension of the of the web voids. After expanding, the member can be heat treated to strengthen a portion of the member, for example, by heating the portion of the member for a period of time, or the entire member, and quenching the member. The member can have a yield strength of between 10 and 200 ksi.

An alternative method of manufacturing the expanded web is to apply heat to change the mechanical properties of the metal prior to or during expansion. The heat can be used in to anneal the material according to acceptable practices. This can be accomplished by heating and cooling to remove residual stress and work hardening that has taken place during the rolling process of steel manufacture. Annealing can maximize the ability to cold form and expand the web. In another example, the heat can be applied to heat the material to a temperature that can allow the web to be formed, or expanded, while in the elevated temperature state. After forming, the material can be cooled in whatever method or at whatever speed is desired to obtain the final desired mechanical properties. The second process allows the ability to create a higher strength steel product and significantly improve the mechanical properties of the stud if desired. In each method, the heat can be applied locally or globally to the material as desired.

Recesses 104 in flange 102 can be formed at the same time as web slots 106, or before or after web slots 106 are formed. During the roll forming process, recesses 104 can be formed with a stamping die, a configured roll, laser or any other suitable method of creating the web slot. The configuration of recesses 104 can be adjusted to accommodate any desired location and number in order to create a framing member that enhances the thermal performance, cost reduction, tradesperson access, structural enhancement or any other desired objective not currently realized.

A number of embodiments have been described. Nevertheless, it will be understood that various modifications may be made without departing from the spirit and scope of the concepts described above. Accordingly, other embodiments are within the scope of the following claims.

What is claimed is:

1. A method of manufacturing a framing member comprising:
providing a formed metal sheet having a length;
forming a plurality of recesses configured to receive and hold a screw tip in a region of the length.

2. The method of claim 1, wherein the region is a flange.

3. The method of claim 1, wherein the region is a connecting region.

4. The method of claim 1, wherein forming a plurality of recesses includes piercing the region.

5. The method of claim 1, wherein forming a plurality of recesses includes stamping the region.

6. The method of claim 1, wherein each recess includes a barrel.

7. The method of claim 1, wherein the plurality of recesses are configured in an array spaced specifically to allow the screw tip to easily find a recess without special consideration of the operator.

8. The method of claim 1, wherein the recess has a diameter and depth sufficient to capture a portion of a thread of a screw.

9. A method of claim 1, wherein the formed metal sheet has a length, a web region and a flange and the method further comprises:
placing a plurality of slots along a portion of the length in the web region;
forming a plurality of recesses in the flange; and
expanding the slots of the web region to form expanded slots having a web element and a web void, the metal sheet being heat treated.

10. The method of claim 9, wherein providing the formed metal sheet includes roll forming a metal sheet.

11. The method of claim 9, wherein forming a plurality of recesses includes piercing the flange.

12. The method of claim 9, wherein forming a plurality of recesses includes stamping the flange.

13. The method of claim 9, wherein the recess has a diameter and depth sufficient to capture a portion of a thread of a screw.

14. A metal framing member comprising:
a formed metal sheet having a length;
a plurality of recesses configured to receive and hold a screw tip in a region of the length.

15. The metal framing member of claim 14, wherein the region is a flange.

16. The metal framing member of claim 14, wherein the region is a connecting region.

17. The metal framing member of claim 14, wherein each recess includes a barrel.

18. The metal framing member of claim 14, wherein the plurality of recesses are configured in an array spaced specifically to allow the screw tip to easily find a recess without special consideration of the operator.

19. The metal framing member of claim 14, wherein the recess has a diameter and depth sufficient to capture a portion of a thread of a screw.

20. The metal framing member of claim 14, wherein the formed metal sheet includes a web region and a flange, and a plurality of expanded slots along a portion of the length in the web region, and a portion of the plurality of recesses are in the flange and each recess has a diameter and depth sufficient to capture a portion of a thread of a screw.
